(19) United States
(12) Patent Application Publication
(10) Pub. No.: US 2026/0081326 A1
(43) Pub. Date: Mar. 19, 2026

(54) ELECTROLYTE FILLING AND SOAKING ACCELERANT SYSTEMS AND METHODS

(71) Applicant: TITAN ADVANCED ENERGY SOLUTIONS, INC., Salem, MA (US)

(72) Inventors: Edward M. MINASIAN, Arlington, MA (US); Andrew CANNON, Marblehead, MA (US); Shawn D. MURPHY, Wenham, MA (US); Georgios KAPODISTRIAS, Reading, MA (US)

(21) Appl. No.: 19/329,220

(22) Filed: Sep. 15, 2025

Related U.S. Application Data
(60) Provisional application No. 63/695,551, filed on Sep. 17, 2024.

(51) Int. Cl. H01M 50/609

(52) U.S. Cl. CPC H01M 50/609

(57) ABSTRACT

Electrolyte filling and soaking acceleration systems and methods are disclosed. An exemplary system for electrolyte acceleration of battery cells, such as lithium ion battery cells or similar products, includes an electrolyte conditioning system and an assessment system. The electrolyte conditioning system can accelerate the filling and soaking process by transmitting ultrasound of a first ultrasound frequency, loaded from excitation parameters, into the battery cells to reduce electrolyte surface tension. The reduced surface tension enables the electrolyte to more easily infiltrate each battery cell and its structures, eliminating both pockets of unfilled electrolyte within the battery cell and gas bubbles in the electrolyte. The assessment system can perform ultrasound interrogation of the battery cell at a second frequency, generate soak characteristic data in response to the interrogation, and use the soak characteristic data to adjust the excitation parameters of the conditioning system to improve its performance.

### CROSS-REFERENCE TO RELATED APPLICATION(S)

This application claims benefit of and priority under 35 U.S. C. § 119(e) to and is a non-provisional of U.S. Provisional Application No. 63/695,551, filed Sep. 17, 2024, entitled “Electrolyte Filling and Soaking Accelerant Systems and Methods,” which is incorporated by reference herein in its entirety.

### COPYRIGHT NOTICE

A portion of the disclosure of this patent document may contain material that is subject to copyright or trademark protection. The copyright or trademark owner has no objection to the facsimile reproduction by anyone of the patent document or the patent disclosure, as it appears in the Patent and Trademark Office patent files or records, but otherwise reserves all trademark rights whatsoever. The following notice shall apply to this document: IonSight™, which is a trademark that has been applied for by Titan Advanced Energy Solutions, Inc.

### FIELD

The present disclosure relates generally to energy storage devices (e.g., battery cells), and more particularly, to enhancement of electrolyte filling and soaking processes for energy storage devices, for example, using ultrasound.

### BACKGROUND

The electrolyte filling and soaking processes can be crucial stages in the manufacture of lithium-ion batteries and other types of batteries. These stages ensure that the electrolyte delivery includes the correct volume of electrolyte and that the electrolyte fully saturates the electrodes and the separator, enabling efficient ion transport during battery operation. However, several issues can arise during these processes, which can impact the performance, safety, and longevity of the batteries. Specific issues with electrolyte filling and soaking processes can include, but are not limited to, incomplete saturation, air entrapment, electrolyte wettability, contamination, swelling, temperature sensitivity, filling and soaking time, filling and soaking cost, and volume expansion.

Regarding incomplete saturation, if the electrolyte does not fully saturate the battery's internal components, it can lead to dry spots within the cell. This incomplete saturation can cause uneven current distribution, leading to poor battery performance accelerated degradation and potential to develop into defects such as lithium plating. In regard to air entrapment, air bubbles can become trapped in the battery during the filling process, particularly if the electrolyte is improperly introduced or its viscosity is not properly managed. These air pockets prevent necessary contact between the electrode, electrolyte, and separator materials, reducing the effective surface area for ion exchange and potentially causing hot spots or internal short circuits. Relating to electrolyte wettability, the wettability of the separator and electrodes by the electrolyte is critical. Poor wettability can slow down or hinder the soaking process. This results in longer production times and can affect the uniformity of electrolyte distribution, impacting battery quality and consistency.

For contamination issues, the electrolyte or battery components during filling can introduce or cause the migration of impurities that affect battery chemistry. Contaminants can lead to internal short circuits, reduced capacity, and faster degradation. Maintaining a clean production environment is essential but challenging. With swelling, some battery materials can swell abnormally upon electrolyte absorption during the soaking process. Abnormal swelling can stress the battery casing and separators, potentially leading to mechanical failure or reduced cycle life. In regard to temperature sensitivity, the electrolyte filling and soaking processes are sensitive to temperature, which can affect the viscosity of the electrolyte and the expansion of battery components. Temperature variations can lead to inconsistent soaking times and affect the overall battery performance and safety. Proper soaking requires time to ensure complete saturation and uniform electrolyte distribution, which also adds cost. As a result, this process can significantly add to the manufacturing time and cost. Balancing the efficiency of the soaking process with production throughput is a challenge, especially for high-volume manufacturers looking to reduce costs. Finally, with volume expansion, the volume of the electrolyte can expand during operation due to temperature changes and electrochemical reactions. If it is not properly accounted for during the filling process, this expansion can lead to increased internal pressure, risking battery rupture or leakage.

Electrolyte interrogation for batteries refers to a set of techniques and methodologies used to assess, monitor, and understand the condition, performance, and safety of batteries, for example, lithium-ion batteries. These techniques and methodologies can be used to assess the quality and efficacy of the battery related to its electrolyte process performance. These techniques and methodologies can also play a role in optimizing battery usage, extending life spans, and ensuring safety in various applications, from consumer electronics to electric vehicles and renewable energy storage systems.

Electrolyte interrogation in batteries involves analyzing and monitoring the electrolyte's condition and its interactions with other battery components to understand the state of health, performance, and potential failure modes of the batteries. While this is a critical aspect of ensuring battery reliability and safety, several issues can arise during the interrogation of battery electrolytes such as, but not limited to, the complexity of the electrolyte composition, sensitivity of the electrolyte to environmental conditions, the difficulties of non-invasive interrogation, electrolyte degradation products, interactions with battery components, data interpretation and analysis, cost and accessibility.

Regarding the complexity of the electrolyte composition, modern battery electrolytes are complex mixtures, often containing various salts, solvents, and additives. This complexity can make it challenging to precisely analyze and interpret the electrolyte's condition and its impact on battery performance. Without a comprehensive understanding of electrolyte behavior, it can be difficult to diagnose performance issues or predict battery lifespan accurately. With respect to environmental conditions, the electrolyte's properties can be sensitive to temperature, pressure, and humidity, which can alter its performance and the accuracy of interrogation results. Variations in environmental conditions can lead to inconsistent or misleading data about the electrolyte's condition, complicating the diagnosis of battery issues. In regard to the difficulties of non-invasive interrogation, ideally, electrolyte interrogation should be non-invasive to avoid damaging the battery. However, obtaining detailed information about the electrolyte's condition without physically accessing the inside of the battery can be challenging, which can hinder real-time monitoring and the ability to respond promptly to changing conditions within the battery.

Electrolyte filling technology in batteries requires quality control and efficiency during the manufacturing process. The electrolyte wetting process, which may be important for battery health and performance, can involve the electrolyte fluid penetrating the porous structures of electrodes and separators. This wetting process should be complete and evenly distributed to prevent issues such as poor electrochemical performance and shortened battery life. Conventional technologies to optimize electrolyte wetting utilize numerical models developed from computational fluid dynamics. These numerical models assess process parameters such as pressure, temperature, and the like on electrolyte filling. Experimental methods such as neutron radiography are used to verify the computational fluid dynamic simulations.

Electrolyte wetting and battery health are related because the wetting and soaking processes are the most critical for battery performance. Various experimental techniques are employed to assess battery health. Methods like electrochemical impedance spectroscopy and chronoamperometry can measure the degree of battery wetting and identify defects like gas entrapments within the cell structure. Visual methods, including x-ray computer tomography (CT) inspection and neutron radiography, offer insights into the progression of wetting. However, these methods are not as suitable for inline process control due to their invasive or complex nature and are somewhat limited by physics as to what they can detect.

After the electrolyte wetting stage, the battery cells enter a formation stage. During the formation stage, the battery cells are charged and discharged several times to activate the electrode materials and to determine whether the battery cells meet the required capacity. Battery cells which do not meet the required capacity are scrapped and indicate issues in the wetting process. If the required cell capacity is met, the battery cells then proceed to aging and final testing stages. After final testing, the battery cells are assembled into battery packs.

Bubbles of air or gas in the electrolyte of completed battery cells are especially problematic. The bubbles make it more difficult (and sometimes impossible) to detect some problems or failure modes of the batteries via ultrasound interrogation. This is because the bubbles can absorb, deflect, and/or diffract the incident transmitted ultrasound in unpredictable ways. This can result in inconsistent interpretation and analysis of the detected ultrasound (either reflected ultrasound detected in echo-mode, or through-transmitted ultrasound detected in through-transmission mode). As a result, currently available technologies may not be able to detect some problems in lithium ion batteries after the electrolyte wetting and soaking stage, at least until the bubbles are mostly removed or dispersed.

While the bubbles present in the electrolyte impede detection of certain defects in the battery using ultrasound interrogation, the presence of excessive bubbles itself can be interpreted as a potential defect or a quality parameter failure of the cells themselves. Most other conventional or unconventional inspection techniques lack the ability to detect gas to the degree that ultrasound can.

As described above, a significant problem is that conventional electrolyte wetting systems are not able to provide electrolyte wetting assessment during the wetting phase, also known as inline process control. Thus, it is difficult to currently resolve inline process issues with electrolyte filling and soaking processes such as, but not limited to, incomplete saturation, air entrapment, electrolyte wettability, contamination, swelling, temperature sensitivity, filling and soaking time, filling and soaking cost, and volume expansion. Additionally, there is no inline method currently available to optimize the electrolyte fill and soak process. Thus, in order to assess whether the defined process for electrolyte fill or soak is adequate for the production of quality batteries, it often requires a full end-to-end “trial and error” based prototyping process that begins with theory and estimation and ends with several trials with control variables and testing to finalize the electrolyte process parameters.

Embodiments of the disclosed subject matter may address one or more of the above-noted needs, problems, and/or disadvantages, among other things.

### SUMMARY

Embodiments of the disclosed subject matter relate to physical systems, software, and methods for liquid electrolyte filling, soaking, and interrogation of energy storage devices (e.g., batteries. Some aspects of the disclosed technology pertain, in part, to ultrasound-based battery electrolyte interrogation and/or improvement or enhancement of the electrolyte filling and soaking process for energy storage devices (e.g., lithium-ion) and other relevant products.

In some embodiments, the disclosed technology relates to battery electrolyte filling, soaking, and/or interrogation, which may have applications in a variety of areas, such as but not limited to battery manufacturing and maintenance, automotive and electric vehicles (e.g., battery health monitoring and manufacturing optimization), renewable energy storage (e.g., grid storage solutions or portable off-grid power systems), consumer electronics (e.g., smartphones, laptops, and wearable devices), aerospace and defense (e.g., satellites and unmanned aerial vehicles), medical devices (e.g., implantable devices and portable medical equipment), industrial and power tools (e.g., heavy machinery, robotics, and cordless power tools), marine and underwater applications (e.g., submarines, underwater vehicles, and marine energy systems), environmental monitoring systems (e.g., sensors and systems for data capture and analysis), artificial intelligence (e.g., complex data generated from battery interrogation used to train artificial intelligence models for predictive analytics), and material science engineering (e.g., development of new electrolyte materials and filling techniques).

Embodiments of the disclosed subject matter can address one or more shortcomings of conventional electrolyte wetting systems. In some embodiments, ultrasound technology can be utilized during the wetting and/or soaking phases to non-invasively accelerate electrolyte filling of battery cells (or other devices with electrolyte) and/or to provide inline processing assessment of the cells. Embodiments of the disclosed subject matter pertain, at least in part, to ultrasound-based electrolyte interrogation and/or improving the electrolyte filling and soaking process (also known as electrolyte infiltration) for batteries (e.g., lithium-ion batteries) and the like. In some embodiments, ultrasound-based interrogation can reveal more defects and issues in batteries (e.g., lithium-ion batteries) than conventional systems or methods (e.g., X-ray CT, voltage/current measurements, etc.).

In one or more embodiments, a system can comprise a first ultrasound processing system, a second ultrasound processing system, and a controller. The first ultrasound processing system can be configured to emit ultrasound energy at a first frequency into a battery cell to condition an electrolyte of the battery cell. The second ultrasound processing system can be configured to (i) emit ultrasound energy at a second frequency into the battery cell, (ii) detect ultrasound transmitted through or reflected by the battery cell, (iii) generate electrical response signals associated with the detected ultrasound, and (iv) generate soak characteristic data indicative of an electrolyte wetting quality or a soak quality based upon the response signals. The second frequency can be different than the first frequency. The controller can be configured to adjust one or more excitation parameters of the first ultrasound processing system based on the soak characteristic data. In some embodiments, at least one of the first and second ultrasound processing systems can comprise the controller.

In one or more embodiments, a method can comprise applying ultrasound energy to a battery cell at a first frequency, interrogating the battery cell using ultrasound energy at a second frequency different than the first frequency, and adjusting one or more excitation parameters of the applying based at least in part on the interrogating (e.g., based on feedback from the interrogating). In some embodiments, the applying at the first frequency promotes, or is configured to promote, electrolyte infiltration of the battery cell, and the interrogating at the second frequency assesses, or is configured to assess, electrolyte wetting or soak characteristics.

In one or more embodiments, a system can comprise an ultrasound assessment system and a controller. The ultrasound assessment system can be configured to perform ultrasonic interrogation of a battery cell and an electrolyte of the battery cell, and to generate response signals in response to the ultrasonic interrogation. The controller can be configured to correlate the response signals with teardown data of the interrogated battery cell to obtain correlated data. In some embodiments, the controller can be configured to update a software algorithm based on the correlated data, and/or to apply the response signals as input to the software algorithm, which in response creates soak characteristic data as output. In some embodiments, the soak characteristic data can predict electrolyte wetting quality or soak quality of the battery cell. Alternatively or additionally, the controller can be configured to pass the soak characteristic data as input to the ultrasound assessment system. In some embodiments, the ultrasound assessment system can use the soak characteristic data to adjust ultrasound transmitted into other battery cells when performing ultrasonic interrogation of the other battery cells.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the disclosed subject matter. The features of the disclosed subject matter will best be understood from the following detailed description and example embodiments thereof selected for the purposes of illustration and shown in the accompanying drawings in which:

FIG. 1A is a simplified schematic diagram illustrating aspects of an electrolyte acceleration system including an electrolyte conditioning system, according to one or more embodiments of the disclosed subject matter;

FIG. 1B is a simplified schematic diagram illustrating aspects of another electrolyte acceleration system including an electrolyte conditioning system, according to one or more embodiments of the disclosed subject matter;

FIG. 2 is a simplified schematic diagram illustrating aspects of another electrolyte acceleration system, according to one or more embodiments of the disclosed subject matter, where the system includes an electrolyte conditioning system and additionally includes an electrolyte assessment system, and where the conditioning and assessment systems share a common transducer transceiver system;

FIG. 3 is a simplified schematic diagram illustrating aspects of another electrolyte acceleration system, according to one or more embodiments of the disclosed subject matter;

FIG. 4 depicts aspects of an iterative electrolyte conditioning and assessment process according to one or more embodiments of the disclosed subject matter, where the electrolyte assessment system and the electrolyte conditioning system are shown as a combined entity;

FIG. 5 depicts aspects of another iterative electrolyte conditioning and assessment process according to one or more embodiments of the disclosed subject matter, where the electrolyte assessment system and electrolyte conditioning system as shown as separate entities; and

FIG. 6 depicts a generalized example of a computing environment in which the disclosed technologies may be implemented.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the accompanying figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art. The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,”, “upper,” “lower,” “top,” “bottom,” “interior,” “exterior,” “left,” “right,”, “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

It will be understood that although terms such as “first” and “second” are used herein to describe various elements, these elements should not be limited by these terms. Rather, these terms are only used to distinguish one element from another element. For example, a first element discussed below may instead be termed a second element, and similarly, a second element may instead be termed a first element without departing from the teachings of the present disclosure. Moreover, terms such as “first, second,.” in the claims are used to differentiate between elements of a claim and do not add limitations to the claim.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise. As used herein, the term “and/or” includes any and all combinations of one or more of the associated listed items. It will be further understood that the terms “includes,” “comprises,” “has,” “including,” “having,” and/or “comprising,” when used in this specification, specify the presence of stated features, integers, steps, operations, elements, and/or components, but do not preclude the presence of addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present, unless explicitly stated otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined herein can be substituted or unsubstituted.

Unless explained otherwise, all terms (including technical and scientific terms) used herein have the same meaning as commonly understood by one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter, unless specifically indicated otherwise.

Correlate: In the context of this application, “correlate” refers to the process of identifying, determining, or establishing a statistical, mathematical, or logical relationship between two or more variables, data sets, signals, patterns, or features. The correlation may be direct or inferred, and may be based on temporal alignment, similarity metrics, proximity in feature space, or other defined criteria relevant to the disclosed system or method. Correlation may include, but is not limited to, the use of regression models, classification algorithms, heuristic mappings, or rule-based logic to associate input data with a corresponding outcome, state, or classification.

Teardown process: A process for physically opening a structure, such as a battery cell, that involves tearing the structure apart.

### Introduction

Embodiments of the disclosed subject matter will now be described more fully hereinafter with reference to the accompanying drawings, in which illustrative examples are shown. Aspects of the disclosed subject matter may, however, be embodied in many different forms, and the disclosed subject matter should not be construed as limited to the embodiments or examples specifically set forth herein. Rather, this description and accompanying figures are provided so that this disclosure will be thorough and complete, and will fully convey the scope of the disclosed subject matter to those skilled in the art.

In some embodiments, an electrolyte acceleration system can “accelerate” the electrolyte wetting process, for example, by removing gas bubbles in the electrolyte and/or enabling the electrolyte to fill voids in a battery cell and to soak more completely and quickly, due at least in part to the ultrasound energy waves directed by the acceleration system (e.g., an electrolyte conditioning system thereof) at a battery cell during its electrolyte filling and wetting process. In some embodiments, the frequencies for the ultrasound energy are selected such that the ultrasound lowers surface tension barriers that typically form between gas/air pockets and the electrolyte. Alternatively or additionally, the selected ultrasound frequencies can significantly accelerate the dispersion of gas/air bubbles that invariably form in the electrolyte during the wetting and soaking process.

In some embodiments, the electrolyte acceleration/conditioning may be considered a first-stage process, and a subsequent assessment (e.g., also using ultrasound in the same or a different setup) may be used as a second-stage process. In some embodiments, the results of the second-stage assessment can serve as feedback to the first-stage process, for example, for further improving the electrolyte filling and wetting process in the current battery cell and/or subsequent battery cells.

Compared to conventional electrolyte wetting technologies, which can take a week or more to complete the electrolyte wetting and soaking phase, the novel electrolyte acceleration systems according to embodiments of the disclosed subject matter have been experimentally found to reduce the soak time to as little as one day (or less), without compromising battery cell capacity and performance. Moreover, embodiments of the disclosed subject matter can offer more consistent process outcomes and therefore reduce process variability, for example, by using the output of the electrolyte assessment as feedback to the first stage electrolyte conditioning to iteratively improve upon the acceleration of the electrolyte.

### System Examples

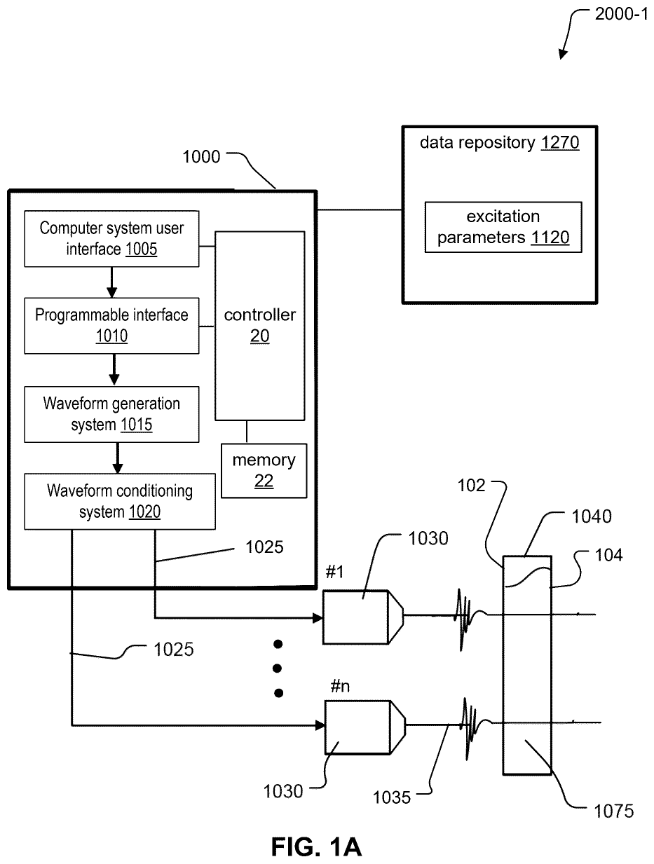

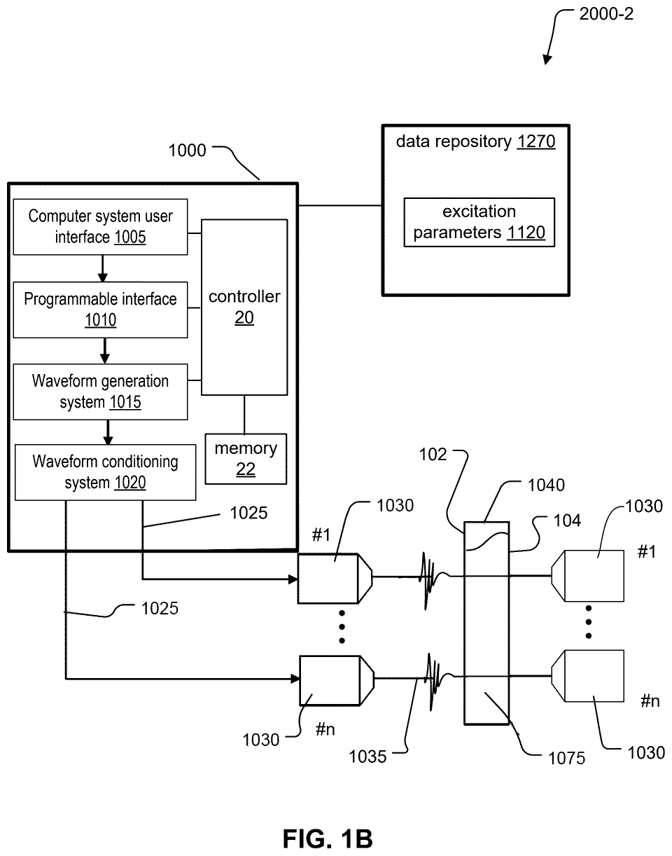

FIGS. 1A-1B show exemplary electrolyte acceleration systems (“acceleration systems”) 2000-1 and 2000-2. The acceleration systems 2000-1 and 2000-2 each include an electrolyte conditioning system 1000, one or more transducers 1030, and a data repository 1270. In some embodiments, the acceleration system 2000-1 or 2000-2 can be configured to process and/or further comprise a battery cell 1040. The data repository 1270 includes excitation parameters 1120. Transmitted ultrasound signals 1035 that are transmitted into the battery cell 1040 are also shown. In the illustrated examples, the battery cell 1040 is a prismatic battery cell with a left surface 102 and a right surface 104 that opposes its left surface 102. In some embodiments, the excitation parameters 1120 can include information associated with ultrasound signals, such as but not limited to frequency, amplitude, pulse repetition rate, waveform shape, and number of pulses, in examples.

In the illustrated examples, the transducers 1030 are labeled as #1 . . . #n. Here, there are two primary arrangements. In the first primary arrangement depicted in FIG. 1A for acceleration system 2000-1, each of the transducers 1030 are placed near or against a same side or surface 102 (or 104) of the battery cell 1040. In the second primary arrangement depicted in FIG. 1B for acceleration system 2000-2, transducers 1030 are placed against or near both sides or surfaces 102, 104 of each battery cell 1040. More than one transducer on a side can be arranged in an array configuration in either of the acceleration systems 2000-1, 2000-2. While only one battery cell 1040 is shown, it should be appreciated that the acceleration systems 2000-1, 2000-2 can include and be configured to process (e.g., test) multiple battery cells 1040, for example, with one or more respective transducers 1030 placed next to surfaces 102, 104 of each of the battery cells 1040.

In some embodiments, one, some, or all of the transducers may be configured as transmitters (e.g., emitting ultrasound at/into the battery), receivers (e.g., detecting ultrasound from the battery), or both. For example, in the illustrated example of FIG. 1B, only the transducers 1030 located adjacent to a left surface 102 of the battery cell 1040 are configured as transmitters and to receive the excitation signals 1025 from the waveform conditioning system 1020. Alternatively or additionally, the one or more of the transducers 1030 located adjacent to the right surface 104 of the battery cell 1040 may be configured as ultrasound transmitters and to receive the excitation signals 1025 from the waveform conditioning system 1020.

In the illustrated examples of FIGS. 1A-1B, the electrolyte conditioning system 1000 includes a computer system user interface 1005, a programmable interface 1010, a waveform generation system 1015, a waveform conditioning system 1020, a controller 20, and a memory 22. In some embodiments, the computer system user interface 1005 can connect and feed into the programmable interface 1010, and the electrolyte conditioning system 1000 can be in communication with the data repository 1270. In examples, the data repository 1270 might be connected to the electrolyte conditioning system 1000 directly (e.g., as shown in both FIGS. 1A-1B) or via a network such as a local area network or remote network (public or private).

In some embodiments, software components, applications, routines or sub-routines, or sets of instructions for causing one or more processors to perform certain functions may be referred to as “interfaces,” “systems,” “modules,” or “engines.” It should be noted that such interfaces, systems, modules, or engines, or any software or computer program referred to herein, may be written in any computer language and may be a portion of a monolithic code base, or may be developed in more discrete code portions, such as is typical in object-oriented computer languages. In addition, the interfaces, systems, modules, engines, or any software or computer program referred to herein, may in some embodiments be distributed across a plurality of computer platforms, servers, terminals, and the like. For example, a given interfaces, systems, modules, or engines may be implemented such that the described functions are performed by separate processors and/or computing hardware platforms. Further, although certain functionality may be described as being performed by a particular interfaces, systems, modules, or engines, such description should not be taken in a limiting fashion. In other embodiments, functionality described herein as being performed by a particular interfaces, systems, modules, or engines may instead (or additionally) be performed by a different interface, system, module, engine, program, sub-routine, or computing device without departing from the spirit and scope of the subject matter described herein.

It should be understood that any of the software interfaces, systems, modules, engines, or computer programs illustrated herein may be part of a single program or integrated into various programs for controlling one or more processors of a computing device or system. Further, any of the software interfaces, systems, modules, engines, or computer programs illustrated herein may be stored in a compressed, uncompiled, and/or encrypted format and include instructions which, when performed by one or more processors, cause the one or more processors to operate in accordance with at least some of the methods described herein. Of course, additional and/or different software interfaces, systems, modules, engines, or computer programs may be included, and it should be understood that the examples illustrated and described with respect to the figures herein are not necessary in any embodiments. Use of the terms “interface,” “system,” “module,” or “engine” is not intended to imply that the functionality described with reference thereto is embodied as a stand-alone or independently functioning program or application. While, in some embodiments, functionality described with respect to a particular interface, system, module, or engine may be independently functioning, in other embodiments such functionality is described with reference to a particular interfaces, systems, modules, or engine for ease or convenience of description only and such functionality may in fact be a part of, or integrated into, another interface, system, module, engine, program, application, or set of instructions for directing a processor of a computing device.

In some embodiments, the instructions of any or all of the software interfaces, systems, modules, engines, or programs described herein may be read into a main memory from another computer-readable medium, such from a read-only memory (ROM) to random access memory (RAM). Execution of sequences of instructions in the software interface(s), system(s), module(s), engine(s), or program(s) can cause one or more processors to perform at least some of the processes or functionalities described herein. Alternatively or additionally, in some embodiments, hard-wired circuitry may be used in place of, or in combination with, software instructions for implementation of the processes or functionalities described herein. Thus, the embodiments described herein are not limited to any specific combination of hardware and software.

In the illustrated examples of FIG. 1A-1B, the controller 20 interfaces with the memory 22 and can operate as a central processing unit (CPU) or a microcontroller, in examples. The controller 20 is in communication with and controls the computer system user interface 1005, the programmable interface 1010, the waveform generation system 1015, and/or the waveform conditioning system 1020. The memory 22 can include instructions that the controller 20 executes to operate and control the electrolyte conditioning system 1000. When the controller 20 is configured as a CPU, in one example, an operating system (not shown) can load the instructions for operating the system 1000 into the memory 22 and schedule the execution of the instructions by the controller 22.

In some embodiments, the electrolyte conditioning system 1000 can operate as follows. The controller 20 instructs the waveform generation system 1015 to load a set of excitation parameters 1120 from the data repository 1270 upon startup. The excitation parameters 1120 can include information associated with creation of analog or digital excitation signals 1025 that the waveform generation system 1015 creates from the excitation parameters 1120. The waveform generation system 1015 then sends the excitation signals 1025 to the waveform conditioning system 1020. The waveform conditioning system 1020 may modify (e.g., condition) the excitation signals 1025 before sending the excitation signals 1025 to the transducers 1030. Examples of waveform excitation signal conditioning can include, but are not limited to, properties that can change the signal amplitude, the bandwidth of the signal, and/or the shape of the signal, and/or characteristics such as a number of periods included in the signal.

The excitation signals 1025 can encode information associated with, or otherwise include, frequency, amplitude, pulse repetition rate, waveform shape, and number of pulses information of ultrasound signals for the transducers 1030 to emit. Examples of the waveform shape include square wave, triangular wave, and/or sinusoid, where any of these shapes can be transmitted in a unipolar or bipolar format. The details of the resulting ultrasound signal emitted by the transducers (e.g., ultrasound amplitude, peak frequency, frequency bandwidth, pulse duration, waveform shape, etc.) may be dependent upon the characteristics of the ultrasound transducers 1030 and the excitation signals 1025. In some embodiments, an operator of the electrolyte conditioning system 1000 can also access the programmable interface 1010 (e.g., via an on-site or remote user interface), for example, to adjust or modify one or more of the excitation parameters 1120.

The transducers 1030 can receive the excitation signals 1025 and can transmit corresponding ultrasound signals 1035 into the battery cell or cells 1040 in response. In some embodiments, the transmitted ultrasound signals 1035 can act to lower the surface tension of the electrolyte 1075 filling the battery cells 1040 and/or to reduce surface tension barriers that form between gas/air pockets in the electrolyte 1075. In some embodiments, this can removes most, if not all, gas bubbles within the electrolyte 1075. In some embodiments, the transmitted ultrasound signals 1035 may also cause the electrolyte to more quickly, completely, and/or uniformly fill and infiltrate the battery cell and its structures (e.g., as compared to conventional techniques), thus accelerating the electrolyte wetting and soaking/filling process and improving its quality.

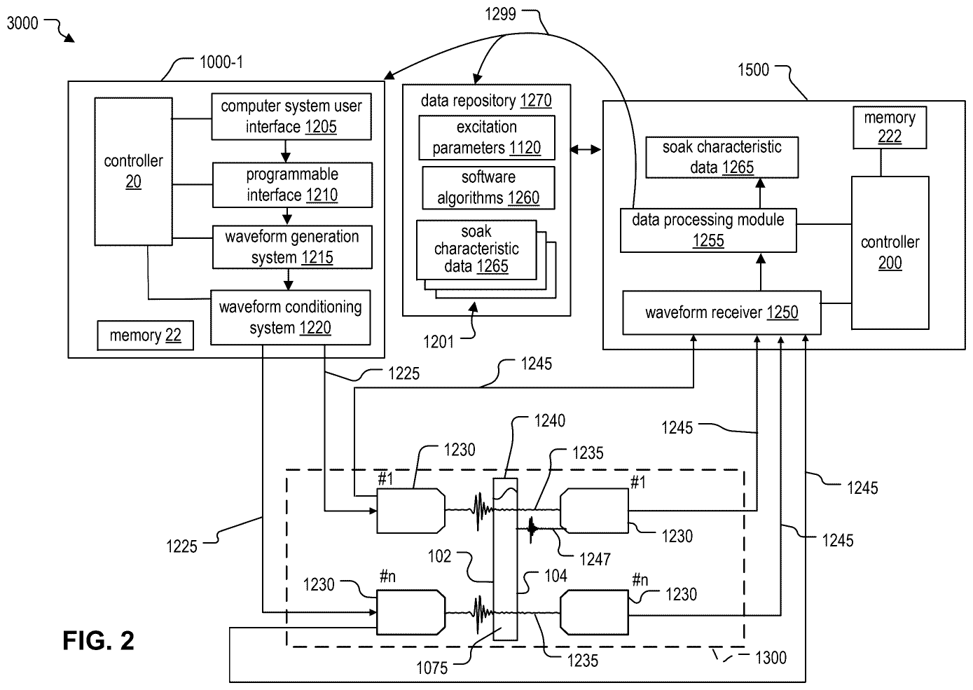

FIG. 2 depicts another acceleration system 3000 designed for processing or otherwise interacting with one or more battery cells 1240. In the illustrated example, the acceleration system 3000 includes an electrolyte conditioning system 1000-1, a transducer transceiver system 1300, a data repository 1270, and an electrolyte assessment system 1500. The electrolyte conditioning system 1000-1 includes similar components and operates in a similar way as the electrolyte conditioning system 1000 of FIGS. 1A and 1B. For example, in FIG. 2, the electrolyte conditioning system 1000-1 includes a computer system user interface 1205, a programmable interface 1210, a waveform generation system 1215, a waveform conditioning system 1220, a controller 20, and a memory 22.

However, the transducers used by the electrolyte conditioning system 1000-1 are included in a transducer transceiver system 1300 that is shared between the electrolyte conditioning system 1000-1 and the electrolyte assessment system 1500. The transducer transceiver system 1300 includes transducers 1230 that may be positioned on opposing sides of the battery cells 1240. The transducers 1230 can be either a singular transducer alone (#1) or any number (#n) of transducers along with the first singular transducer (#1). The electrolyte assessment system 1500 can be utilized to iteratively improve the performance of the electrolyte conditioning system 1000-1.

The data repository 1270 includes software algorithms 1260 used by the electrolyte assessment system 1500 and stores soak characteristic data 1265 generated by the electrolyte assessment system 1500. Because the data repository 1270 can include multiple instances of soak characteristic data 1265 generated by the electrolyte assessment system 1500 over time, for one or more battery cells, the collection of stored soak characteristic data 1265 at the data repository 1270 is also known as historical data 1201.

In some embodiments, the software algorithms 1260 may include machine learning models. For example, these machine learning models may include or otherwise incorporate a variety of learning algorithms, such as but not limited to neural networks, regression trees, decision trees, random forests, support vector machines (SVM), k-nearest neighbors (KNN), and linear or logistic regression. Depending on the application, unsupervised methods such as clustering (e.g., k-means, hierarchical clustering, DBSCAN) or dimensionality reduction techniques (e.g., PCA, t-SNE, UMAP) can be used to uncover latent structure in the soak characteristic data 1265. In some embodiments, the machine learning models can be trained in a supervised fashion using labeled historical data 1201, where outcomes are known and can be mapped against soak characteristic data 1265 and response signals 1245 obtained from new battery cells. In some cases, the models might be trained in an unsupervised manner to detect anomalies, clusters, or novel patterns across cell populations. Semi-supervised and reinforcement learning approaches may also be considered when only partial labeling is available, or when sequential decision-making is important (e.g., adaptive testing strategies).

In some embodiments, training data sets used for training the software algorithms 1260 may include historical data for battery cells of the same type as the current battery cell under test, historical data for battery cells of a different type than the current battery cell, or a combination of both. In some embodiments, ensemble methods that combine predictions from multiple model classes may be deployed to maximize, or at least improve, robustness, accuracy, and/or generalizability across varied operating conditions. In some embodiments, the training data could also include the historical data 1201, possibly in combination with the response signals 1245 generated for, and associated with, some or all of the instances of soak characteristic data 1265 included in the historical data 1201. Training data sets used for this purpose might include historical data 1201 for battery cells of a same type as the current battery cell under test, historical data for battery cells of a different type than the current battery cell, or a combination of same and different battery cell types.

In the illustrated example of FIG. 2, the electrolyte assessment system 1500 includes a data processing module 1255, a waveform receiver module 1250, a controller 200, and a memory 222. In some embodiments, the controller 200 can interfaces with memory 222. The memory 222 can include instructions that the controller 200 executes to operate and control the electrolyte assessment system 1500. In some embodiments, the controller 200 can also communicate with and/or control the data processing module 1255 and the waveform receiver module 1250. In examples, the controller 200 can operate as either a CPU or a microcontroller. When the controller 200 is configured as a CPU, in one example, an operating system (not shown) can load the instructions for operating the system 1500 and its components into the memory 222 and schedule the execution of the instructions by the controller 200.

In the illustrated example of FIG. 2, the transducers 1230 can be positioned such that ultrasound signals 1235 can be transmitted into the battery cell 1240 and detected by transducers directly opposed to one another. Other configurations/arrangements for directing ultrasound into the battery cell and/or detecting ultrasound from the battery cell are also possible according to one or more contemplated embodiments.

In some embodiments, the acceleration system 3000 can operates as follows. The battery cell 1240 and its electrolyte 1075 can be loaded into the shared transducer transceiver system 1300. The electrolyte conditioning system 1000 can transmit ultrasound of a first frequency into the battery cell 1240 to condition its electrolyte 1075. For this purpose, the controller 20 instructs the waveform generation system 1215 to generate excitation signals 1225, which the waveform generation system 1015 forwards to the waveform conditioning system 1220. The excitation signals 1025 are of a first ultrasound frequency, for example, in a range of 20-400 kHz, inclusive. Alternatively or additionally, the first ultrasound frequency can be in a range of 1-400 kHz, inclusive (e.g., 1-100 kHz, inclusive, or 20-400 kHz, inclusive).

In some embodiments, the controller 20 can instruct the waveform conditioning system 1220 to modify the excitation signals 1225 before the waveform conditioning system 1220 transmits the excitation signals 1025 to the transducers 1230. In some embodiments, such instruction by the controller 20 may be in response to and/or based on input from an operator, for example, via the computer system user interface 1205 and/or the programmable interface 1210. In response to receiving the excitation signals 1225, the transducers 1230 can emit ultrasound signals 1235 corresponding to the excitation signals 1225. The ultrasound signals 1235 are transmitted into the battery cell(s) 1240.

As discussed above, the ultrasound signals 1235 transmitted into the battery cell(s) 1240 can lower the surface tension of the electrolyte 1075 filling the battery cell(s) 1240, which can remove gas bubbles (e.g., most, if not all) in the electrolyte and/or improve flow of the electrolyte. As a result, the electrolyte can more easily penetrate electrode surfaces and fill previously unfilled voids, in examples. Experimentation by the present inventors has shown that the conditioning system 1000-1 improves upon conventional techniques by soaking the battery cell and its structures more completely and completes the electrolyte wetting and soaking phase in less time than the conventional techniques. Thus, the electrolyte conditioning system 1000-1 accelerates and improves the quality of the electrolyte wetting and soaking processes.

In some embodiments, after the electrolyte conditioning system 1000-1 completes its ultrasonic conditioning of the electrolyte 1075 in the battery cell 1040, the battery cell 1040 (with electrolyte 1075 therein) can remain within the transducer transceiver system 1300. The electrolyte assessment system 1500 can then perform an ultrasound interrogation session upon the same battery cell(s) 1240 (or battery cell(s) 1040 in FIGS. 1A-1B). For this purpose, the transducers 1230 can transmit ultrasound signals 1235 of a second ultrasound frequency into the battery cell(s) 1240 and the electrolyte 1075. In some embodiments, the second ultrasound frequency is selected to be different from the first ultrasound frequency, for example, greater than the first ultrasound frequency. For example, in some embodiments, the second ultrasound frequency can be in a range from 200 kHz to 20 MHz, inclusive.

During the ultrasound interrogation, the ultrasound transducers 1230 can convert the detected ultrasound (transmitted through and/or reflected from the battery cell 1240) into the response signals 1245, and send the response signals 1245 to the waveform receiver module 1250. The waveform receiver module 1250 can forward the response signals 1245 to the data processing module 1255. The data processing module 1255 can then apply software algorithms 1260 to the response signals 1245 to create the soak characteristic data 1265. The soak characteristic data 1265 can then be stored in the data repository 1270.

In some embodiments, each of the transducers 1230 can be configured to operate in through-transmission mode or echo mode. When the transducers 1230 are configured to operate in through-transmission mode, a pair of transducers 1230 are placed on opposite sides of a respective battery cell 1240 and centered along a common transmission/reception axis. One of the transducers 1230 in the pair is configured as an ultrasound source and transmits ultrasound 1235 into the cell 1240 along the axis, and the opposing transducer is configured as an ultrasound receiver. The ultrasound receiver detects the ultrasound transmitted through the cell (transmitted ultrasound 1235) at the opposing side of the cell 1240 and generates an electrical response signal 1245 associated with the detected ultrasound. When a transducer 1230 is configured to operate in echo mode, the transducer 1230 is configured to transmit ultrasound into the cell, to detect ultrasound reflected back from the cell 1240, and to generate an electrical response signal 1245 associated with the detected ultrasound.

In some embodiments, the transmitted ultrasound signal 1235 additionally reflects out of the battery cell 1240, which is also known as a reflected signal 1247, which the transducers can also detect. In many cases, the response signals 1245 generated by the transducers are associated with through-transmitted ultrasound signals 1235 detected by transducers located at both sides of the battery cell 1240. Note that the reflected signals 1247 may also be detected by transducers on one or both sides of the battery cell 1240 and converted to the response signals 1245.

In some embodiments, the electrolyte assessment system 1500 can access the response signals 1245 from the interrogation session of the battery cell 1240 and analyzes the response signals 1245. The electrolyte assessment system 1500 can create soak characteristic data 1265 in response to the analysis. Based upon the soak characteristic data 1265, the electrolyte assessment system 1500 can make changes to aspects of the electrolyte conditioning system 1000-1, to aspects of the electrolyte assessment system 1500, and/or to the assessment system 3000 as a whole.

In some embodiments, at startup of the electrolyte assessment system 1500, the controller 200 or the waveform receiver module 1250 can load the software algorithms 1260 (also known as battery manufacturing control algorithms) into the memory 222 from the data repository 1270. The waveform receiver module 1250 can receive the response signals 1245 generated by and sent from the transducers 1230 of the transducer transceiver system 1300. The controller 200 can instruct the waveform receiver module 1250 to forward the response signals 1245 to the data processing module 1255. The data processing module 1255 can access the memory 222 and can apply one or more of the software algorithms 1260 to the response signals 1245.

In response, the data processing module 1255 can calculate and/or extract one or more ultrasound features from the response signals 1245. For example, the ultrasound feature(s) can include, but are not limited to, a number of zero-crossings, a time of flight, a maximum value, a minimum value, a waveform shape, an amplitude of the response signal(s), and/or a phase of the response signal(s). In some embodiments, the data processing module 1255 may perform additional calculations upon the “raw” response signals and/or upon the extracted ultrasound features, in various domains, in examples. For example, these domains can include, but are not limited to, a spatial domain, energy domain, resonant domain, non-resonant domain, a time domain, a frequency domain, and/or a context domain.

In some embodiments, the data processing module 1255 can create time-stamped soak characteristic data 1265 as an output. For example, the soak characteristic data 1265 can be indexed by a unique identifier of each battery cell, such as a battery ID. The soak characteristic data 1265 can be stored to the data repository 1270 and/or added to the stored historical data 1201. In some embodiments, the soak characteristic data 1265 can be utilized by the data processing module 1255, for example, to determine and/or apply changes to the electrolyte assessment system 1500, the electrolyte conditioning system 1000-1, and/or the acceleration system 3000 as a whole. In some embodiments, the soak characteristic data 1265 can be accessed and/or updated over time, reloaded into various systems, applied to new systems (e.g., separate but similar systems), and/or tailored to new challenges.

In some embodiments, the historical data 1201 can include stored instances or records of time-stamped soak characteristic data 1265 obtained by the electrolyte assessment system 1500 over time, for example, for interrogation sessions of each battery cell that is a target of the electrolyte assessment system 1500. In some embodiments, the historical data 1201 can also include time-stamped records of the response signals 1245 that the electrolyte assessment system 1500 generates for each battery cell. For example, for this purpose, during an interrogation session of a battery cell, the data processing module 1255 can create a time-stamped record of the response signals 1245 (e.g., indexed by the battery ID) and can save the record to the historical data 1201 in a format suitable for storage. Alternatively or additionally, in some embodiments, the data processing module 1255 can create one or more links within the soak characteristic data 1265 that point to the associated record(s) of response signals 1245.

In some embodiments, the soak characteristic data 1265 can include ultrasound waveforms, and/or electrical representations thereof, that represent certain transmission and reflection characteristics of one or more battery cells. In some embodiments, the soak characteristic data 1265 can be evaluated using machine learning algorithms, AI analysis, and/or human-based analysis, for example, to determine whether the data is representative of uniform soak properties or non-uniform soak properties. In some embodiments, these characteristics and algorithms can, in turn, be used as metrics to provide feedback into soak quality and completion of soaking of electrolyte across the entirety of the battery cell structure.

Although FIG. 2 illustrates a particular arrangement and location of elements, embodiments of the disclosed subject matter are not limited thereto. Rather, it should be appreciated that elements of the electrolyte assessment system 1500 can be located on a remote server, or otherwise be included as components of a system located on a remote server. For example, such elements can include, but are not limited to, soak characteristic data 1265, data repository 1270, data processing module 1255, and/or software algorithms 1260.

In FIG. 2, changes that the data processing module 1255 can effectuate and/or execute based upon the soak characteristic data 1265 are schematically illustrated by arrows 1299. Such changes to the electrolyte conditioning system 1000-1 can include but are not limited to changes to the stored historical data 1201; alterations to the computer system user interface 1205; modifications to the programmable interface 1210; alterations to the waveform generation system 1215; and alterations to the excitation parameters 1120/excitation signals 1225, for future electrolyte conditioning processing of the same battery cell or other battery cells 1240.

Alternatively or additionally, the data processing module 1255 can make changes to the stored historical data 1201 based upon the soak characteristics data 1265. Such changes may include, but are not limited to:
1) appending the soak characteristic data 1265 obtained for each new battery cell (and possibly additional instances/records of soak characteristic data 1265 for already-assessed battery cells) to the historical data 1201;
2) data labeling/tagging: the data processing module 1255 may annotate one or more records within the historical data 1201 with contextual metadata (e.g., ‘outlier’, ‘suspect cell’, ‘training example’, etc.);
3) weighting/prioritization: the data processing module 1255 may up-weight or down-weight prior soak characteristic data 1265 when newer data 1265 indicates a drift or correction;
4) aggregation/summarization: the data processing module 1255 may condense one or more records of the soak characteristic data 1265 within the historical data 1201 into statistical summaries (e.g., means, variances, frequency-domain features, etc.) for efficient future use, and/or to create separate statistical summaries for one or more records while leaving the original records of soak characteristic data 1265 intact;
5) data pruning: the data processing module 1255 may delete or archive redundant records of soak characteristic data 1265, for example, to maintain relevance; and/or
6) cross-cell correlation data creation and storage: the data processing module 1255 may compare records of soak characteristics data 1265 across different battery cells to obtain trends, to link records together based on the comparisons, and/or to create comparative baselines.

Alternatively or additionally, the data processing module 1255 can make changes to the excitation parameters 1120/excitation signals 1225 based upon the soak characteristic data 1265. For example, using the soak characteristic data 1265 obtained for a battery cell, the data processing module 1255 can modulate the frequency and/or amplitude in the excitation parameters 1120 for use during electrolyte wetting and soaking of either the same battery cell or of other battery cells. In some embodiments, the modulation of the frequency and/or amplitude in the excitation parameters 1120 can cause corresponding modulation of the resulting excitation signals 1025, and the modulated excitation signals 1025 can cause the transducers 1230 to emit correspondingly modulated transmitted ultrasound signals 1235. In some embodiments, the other battery cells are of a same type as the battery cell; however, the other battery cells may instead be of a different type than the battery cell. Example types include prismatic and cylindrical.

In some embodiments, the data processing module 1255 can also modify aspects of the electrolyte assessment system 1500 based upon the soak characteristic data 1265. These modifications can include, but are not limited to, modifications to the software algorithms 1260 and/or to processing tasks and instructions included within, and performed by, the data processing module 1255, in examples. Examples of modifications to the software algorithms 1260 can include, but are not limited to:
1) retraining/incremental learning: the soak characteristic data 1265 can be incorporated into training data sets to refine machine learning models (e.g., retraining regression trees, neural nets, or random forests) to improve predictive accuracy for future electrolyte assessments;
2) parameter tuning: instead of full retraining, the data processing module 1255 may adjust algorithm hyperparameters (e.g., learning rates, regularization coefficients, thresholds for anomaly detection) based on observed deviations in the soak characteristic data 1265;
3) adaptive model selection: the data processing module 1255 may choose between different algorithms dynamically (e.g., switching from a neural network to a simpler regression model if the soak characteristic data 1265 indicates low variance);
4) updating rule-based logic: beyond machine learning, if there are deterministic rules (e.g., threshold triggers, conditional flags), these rules can be modified based on evolving soak characteristic data 1265 distributions; and/or
5) feedback loop algorithms: the soak characteristic data 1265 may be used to refine decision policies (e.g., like reinforcement learning) and/or optimize future excitation parameters 1120 or testing protocols.

In some embodiments, the software algorithm 1260 can include a neural network that is configured to predict electrolyte wetting quality of the electrolyte 1075 of a battery cell 1240. For example, the controller 200 or the data processing module 1255 can pass the response signals 1245 as input to the software algorithm 1260 and can obtain a predicted electrolyte wetting quality of the electrolyte 1075 as output. In some embodiments, the software algorithm 1260 may be trained using training data that includes response signals 1245 obtained from other battery cells 1240 (e.g., of the same type or a different type).

In some embodiments, the data processing module 1255 can modify its own processing tasks and/or capabilities based upon the soak characteristic data 1265, for example, for analyzing the response signals 1245. Examples of modifications by the data processing module 1255 can include, but are not limited to:
1) pre-processing adjustments: trends that the module 1255 identifies in the soak characteristic data 1265 may trigger the module 1255 to change filtering tasks (e.g., noise reduction, baseline subtraction, outlier removal strategies, etc.);
2) feature extraction methods: the module 1255 may compute new derived features of/from the response signals 1245 (e.g., time-to-equilibrium, rate-of-change of impedance, variance across frequency bands, etc.) based on identified trends in the soak characteristic data 1265;
3) dynamic windowing: a time-window and/or sampling rate for signal capture of the response signals 1245 may be altered depending on the richness of the soak characteristic data 1265 (e.g., finer sampling if anomalous signals are detected);
4) different statistical models: the data processing module 1255 might change its statistical model for analyzing the response signals 1245, for example, from simple moving averages to Kalman filters or wavelet transforms when the soak characteristics data 1265 indicates instability; and/or
5) adaptive thresholds: processing thresholds (e.g., what counts as “acceptable electrolyte behavior”) can shift based on aggregated soak characteristic data 1265 from multiple battery cells that the data processing module 1255 collects and analyzes across multiple battery cells.

In some embodiments, the data processing module 1255 can make broader changes to the electrolyte acceleration system 3000 based upon the soak characteristic data 1265. Such changes can include, but are not limited to:
1) measurement scheduling: adjust when and/or how often a cell is re-assessed;
2) electrolyte conditioning profiles: modify soak time, temperature, and/or chemical exposure levels during conditioning;
3) cell routing decisions: flag battery cells for further analysis (e.g., via X-ray, computed tomography (CT), ultrasound, cycling, etc.) and/or divert them from downstream pack assembly;
4) alarm or reporting thresholds: change the sensitivity of warnings for electrolyte anomalies;
5) model library selection: switch to a different library of software algorithms 1260 depending on cell chemistry type or other battery cell features; and/or
6) cross-referencing modules: trigger a re-analysis of historical data 1201 across multiple cells if anomalies appear in new soak characteristic data 1265.

In some embodiments, the soak characteristic data 1265 can include information associated with ultrasound attenuation, time-of-flight, backscatter, phase shift, and/or resonance behavior of ultrasound used during the interrogation of the associated battery cell. In some embodiments, the soak characteristic data 1265 may also include information that evaluates and/or ranks a soak quality of the electrolyte. For example, the data 1265 can include an electrolyte wetting index, such as a fractional or logarithmic number in a range from 0 to 10 that indicates a level of wetting (e.g., a value of 10 indicates that no gas/air bubbles or voids were detected). Alternatively or additionally, the electrolyte assessment system 1500 (e.g., data processing module 1255 thereof) might compute an electrolyte wetting index from the soak characteristic data 1265.

In some embodiments, the assessment system 3000 may be configured for semi-automatic or automatic operation. For example, one of the salient changes that the data processing module 1255 can make to the excitation parameters 1120 (e.g., based on the soak characteristic data 1265) is the value of the first ultrasound frequency used by the electrolyte conditioning system 1000-1 to condition a particular battery cell. In some embodiments employing automatic operation, an operator may simply load a battery cell 1240 into the transducer transceiver system 1300, with excitation parameters 1120 that specify a first ultrasound frequency for use by the electrolyte conditioning system 1000-1 and a second ultrasound frequency for use by the electrolyte assessment system 1500. After the electrolyte conditioning system 1000-1 conditions the battery cell using transmitted ultrasound 1235 of the first ultrasound frequency, the electrolyte assessment system 1500 performs ultrasound interrogation of the same battery cell 1240 using the second ultrasound frequency, and generates soak characteristic data 1265. In some cases, based on the soak characteristic data 1265, the data processing module 1255 may increase or decrease the current value of the first ultrasound frequency. The data processing module 1255 may then signal the controller 200 to instruct the controller 20 of the electrolyte conditioning system 1000-1 to perform another conditioning cycle of the battery cell 1240, for example, in order to improve the electrolyte wetting and soaking of the battery cell. This process can iteratively repeat until an optimum first ultrasound frequency for conditioning of the battery cell 1240 is obtained.

In some embodiments, an electrolyte acceleration system 3000 may be considered to comprise a first ultrasound processing system (e.g., electrolyte conditioning system 1000-1 in FIG. 2), a second ultrasound processing system (e.g., electrolyte assessment system 1500 in FIG. 2) and a controller (e.g., controller 200 in FIG. 2). The first ultrasound processing system can be configured to emit ultrasound energy at a first frequency into a battery cell (e.g., battery cell 1240 in FIG. 2) to condition an electrolyte (e.g., electrolyte 1075 in FIG. 2) supplied to and/or already in the battery cell. In some embodiments, the second ultrasound processing system is configured to emit ultrasound energy at a second frequency (e.g., different than the first frequency) into the battery cell, detect ultrasound transmitted through and/or reflected from the battery cell, generate electrical response signals (e.g., signals 1245 in FIG. 2) associated with the detected ultrasound, and/or generate soak characteristic data (e.g., data 1265 in FIG. 2) indicative of an electrolyte wetting quality and/or a soak quality based upon the response signals. The controller can be configured to adjust one or more excitation parameters (e.g., parameters 1120) of and/or for use by the first ultrasound processing system based on the soak characteristic data.

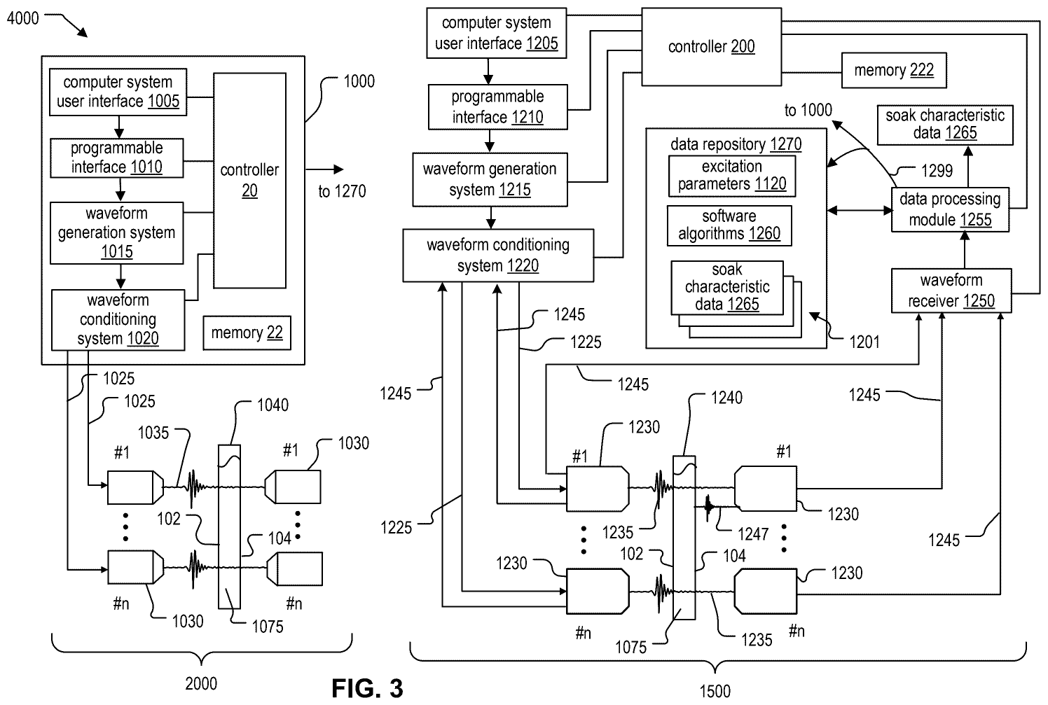

FIG. 3 shows another electrolyte acceleration system 4000. In the illustrated example, electrolyte acceleration system 4000 includes an electrolyte acceleration system 2000 and an electrolyte assessment system 1500. Unlike the acceleration system 3000 of FIG. 2, which includes a common transducer transceiver system 1300 and has a high degree of coupling between its electrolyte conditioning system 1000-1 and electrolyte assessment system 1500, the electrolyte acceleration system 2000 and the electrolyte assessment system 1500 can be considered mostly separate, for example, with their own ultrasound transducers 1030, 1230, respectively. As a result, any battery cells loaded into and subjected to conditioning by the electrolyte acceleration system 2000 can be removed from the electrolyte acceleration system 2000 and transferred to the electrolyte assessment system 1500 (or at least moved between different ultrasound stages). In some embodiments, the transfer of battery cells (e.g., from the location of cell 1040 in system 2000 to the location of cell 1240 in system 1500, or vice versa) and 1240 is a physical transfer from system 2000 to system 1500, for example, via manual means (e.g., an operator handling the battery cell), robotic means (e.g., a robotic arm handling the battery cell), conveyance means (e.g., a conveyor belt moving the battery cell), and/or any other displacement mechanism. In some embodiments, the transfer may be effected by moving the transducers associated with the respective systems 2000, 1500, in addition or instead of physically moving the battery cells. In some cases, battery cell(s) 1040 are the same as battery cell(s) 1240; however, it is also possible that battery cell(s) 1240 differ from battery cell(s) 1040, for example, by the degree of electrolyte filling and wetting.

In the illustrated example, the electrolyte acceleration system 2000 is substantially the same as system 2000-2 in FIG. 1B, while aspects of electrolyte assessment system 1500 are similar to those in FIG. 2. For example, in FIG. 3, electrolyte assessment system 1500 includes a computer system user interface 1205, a programmable interface 1210, a waveform generation system 1215, a waveform condition system 1220, a controller 200, a memory 222, soak characteristic data 1265, a data processing module 1255, a waveform receiver module 1250, and at least one transducer 1230.

In some embodiments, the electrolyte acceleration system 4000 can operate as follows. The electrolyte acceleration system 2000 can perform ultrasonic conditioning of the electrolyte 1075, for example, by having the waveform conditioning system 1020 of electrolyte conditioning system 1000 transmit excitation signals 1025 of a first ultrasound frequency (e.g., in range of 20-400 kHz, inclusive, or in a range of 1-100 kHz, inclusive) into the battery cell 1040. After the electrolyte acceleration system 2000 completes its ultrasonic conditioning, the battery cell 1040 with electrolyte 1075 therein can be are transferred to the electrolyte assessment system 1500, e.g., for interrogation as battery cell 1240. The electrolyte assessment system 1500 can then perform an ultrasound interrogation session upon the battery cell 1240, for example, by having transducers 1230 transmit ultrasound signals 1235 of a second ultrasound frequency into the battery cells 1240 with electrolyte 1075 therein. In some embodiments, the second ultrasound frequency is selected to be different from the first ultrasound frequency (e.g., second ultrasound frequency greater than the first ultrasound frequency). For example, the second ultrasound frequency can be in a range from 200 kHz to 20 MHz, inclusive.

In some embodiments, during the ultrasound interrogation, the ultrasound transducers 1230 can convert the detected ultrasound (either transmitted through or reflected from the battery cell 1240) into the response signals 1245, and send the response signals 1245 to the waveform receiver module 1250. The waveform receiver module 1250 can forward the response signals 1245 to the data processing module 1255, and the data processing module 1255 can apply software algorithms 1260 (and possibly performs other processing) to the response signals 1245 to create the soak characteristic data 1265. The soak characteristic data 1265 can then be stored to the data repository 1270. Alternatively, in some embodiments, the soak characteristic data 1265 may be further processed or reprocessed before being stored in the data repository 1270. In some embodiments, the electrolyte assessment system 1500 can generate a two or three-dimensional ultrasonic image of an interior of the battery cell, for example, based at least in part upon the response signals 1245. In some embodiments, the data processing module 1255 can be configured to execute a machine learning model trained on prior soak characteristic data 1265 to generate updated excitation parameters 1120 for use by the electrolyte conditioning system 2000.

The soak characteristic data 1265 from the data repository 1270 can be utilized to effect iterative changes to the electrolyte conditioning system 1000 and/or the electrolyte assessment system 1500, as indicated schematically by arrow 1299 in FIG. 3. In some embodiments, the processes performed by electrolyte conditioning system 1000 and electrolyte assessment system 1500 processes may be continued iteratively on the battery cell(s) 1040/1240 and its electrolyte 1075, for example, until ideal electrolyte filling and wetting conditions are met.

### Method Examples

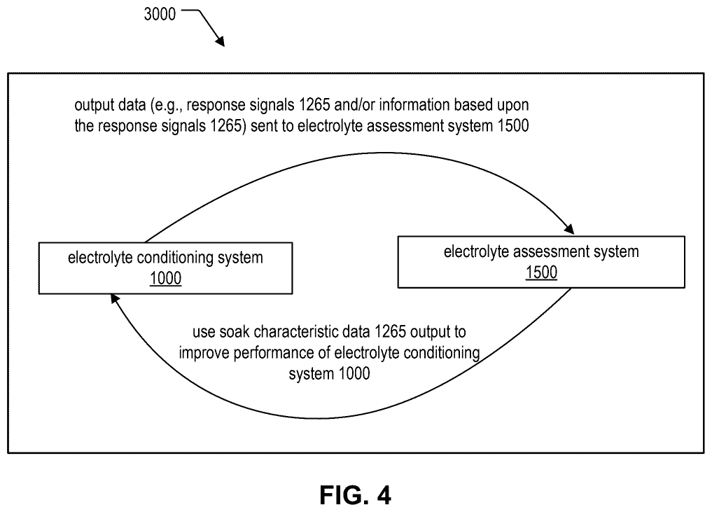

FIG. 4 depicts aspects of an iterative process performed by an electrolyte acceleration system 3000, having an electrolyte assessment system and electrolyte conditioning system combined into a single setup (e.g., as shown by systems 1500 and 1000-1 in FIG. 2). In the illustrated example, the electrolyte to be filled into the battery cell first interacts with the electrolyte conditioning system, which utilizes ultrasound energy to lower the surface tension of the electrolyte and condition the electrolyte for improved filling and wetting and dissolving of gas bubbles. The electrolyte assessment system then transmits ultrasound into the battery cell to evaluate battery cell characteristics (e.g., state of health, state of charge, and/or wetting quality/efficiency) and generates soak characteristic data 1265. In some embodiments, the soak characteristic data can then be used to optimize, or at least improve, performance of the electrolyte conditioning system (e.g., with respect to electrolyte filling and/or wetting). This process can repeat until optimal electrolyte wetting and filling conditions are found, or other predetermined criteria has been met (e.g., a set number of iterations).

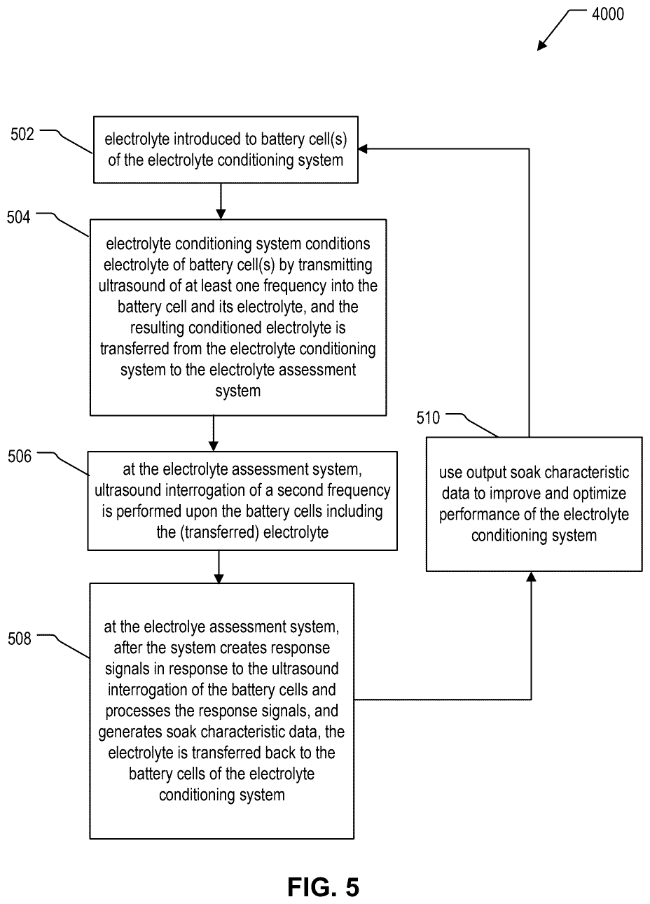

FIG. 5 depicts aspects of an iterative process performed by an electrolyte acceleration system 4000, having an electrolyte assessment system separate from an electrolyte conditioning system (e.g., as shown by systems 1500 and 2000 in FIG. 3). In the illustrated example, the process can initiate at process block 502, where electrolyte can be introduced to the electrolyte conditioning system, for example, during a filling and wetting process of a battery cell. At process block 504, the electrolyte conditioning system can condition the electrolyte by transmitting ultrasound of at least one frequency into the battery cell and/or its electrolyte. In some embodiments, the ultrasound transmission occurs while the electrolyte is being filled into the battery cell. Alternatively or additionally, in some embodiments, the ultrasound directed to the electrolyte already within the battery cell. In some embodiments, process block 504 can further include transferring the resulting conditioned electrolyte (e.g., the processed battery cell having the electrolyte therein) from the electrolyte conditioning system to the electrolyte assessment system.

At process block 506, the electrolyte assessment system 1500 can interrogate the electrolyte within the battery cell (transferred from the electrolyte conditioning system) with ultrasound of a second frequency (e.g., different than at least one frequency used for the conditioning by the electrolyte conditioning system). At process block 508, after the electrolyte assessment system creates the response signals in response to the ultrasound interrogation and processes the response signals, the electrolyte within the battery cell can be transferred from the electrolyte assessment system back to the electrolyte conditioning system. At process block 510, the soak characteristic data output from the electrolyte assessment system can then be used as feedback to improve and/or optimize performance of the electrolyte conditioning system. This process can repeat until optimal electrolyte wetting and filling conditions are found, or other predetermined criteria has been met (e.g., a set number of iterations).

Although some of the steps, blocks, or other aspects of FIGS. 4-5 have been described as being performed once, in some embodiments, multiple repetitions of a particular step, block, or other aspect (or portion thereof) may be repeated before proceeding to the next step. In addition, although steps, blocks, or other aspects of FIGS. 4-5 have been separately illustrated and described, in some embodiments, steps, blocks, or other aspects (or portions thereof) may be combined and performed together (simultaneously or sequentially). Moreover, a particular order is illustrated for steps, blocks, or other aspects of FIGS. 4-5, embodiments of the disclosed subject matter are not limited thereto. Indeed, in certain embodiments, the steps, blocks, or other aspects (or portions thereof) may occur in a different order than illustrated or simultaneously with other steps, blocks, or other aspects (or portions thereof). In some embodiments, a method can include steps, blocks, or other aspects not specifically illustrated in FIGS. 4-5. Alternatively or additionally, in some embodiments, a method may comprise only some of the illustrated and/or described steps, blocks, or other aspects.

### Computer Implementation

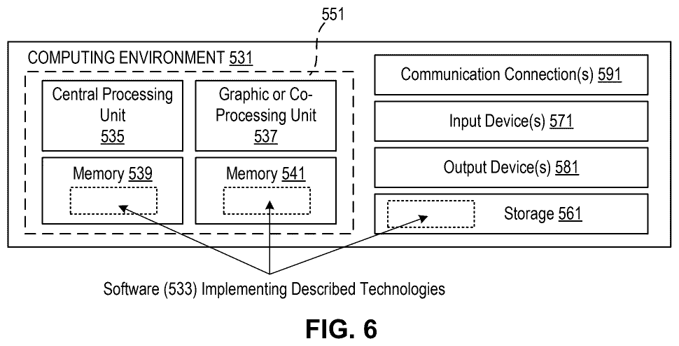

FIG. 6 depicts a generalized example of a suitable computing environment 531 in which the described innovations may be implemented, such as but not limited to aspects of electrolyte acceleration system 2000-1, electrolyte acceleration system 2000-2, electrolyte conditioning system 1000, electrolyte conditioning system 1000-1, controller 20, data repository 1270, electrolyte assessment system 1500, controller 200, and/or the methods of FIGS. 4-5. The computing environment 531 is not intended to suggest any limitation as to scope of use or functionality, as the innovations may be implemented in diverse general-purpose or special-purpose computing systems. For example, the computing environment 531 can be any of a variety of computing devices (e.g., desktop computer, laptop computer, server computer, tablet, etc.).

The computing environment 531 includes one or more processing units 535, 537 and memory 539, 541. In FIG. 6, this basic configuration 551 is included within a dashed line. The processing units 535, 537 execute computer-executable instructions. A processing unit can be a central processing unit (CPU), a processor in an application-specific integrated circuit (ASIC), a microcontroller, or any other type of processor (e.g., hardware processors, graphics processing units (GPUs), virtual processors, etc.). In a multi-processing system, multiple processing units execute computer-executable instructions to increase processing power. For example, FIG. 6 shows a central processing unit 535 as well as a graphics processing unit or co-processing unit 537. The tangible memory 539, 541 may be volatile memory (e.g., registers, cache, RAM), non-volatile memory (e.g., ROM, EEPROM, flash memory, etc.), or some combination of the two, accessible by the processing unit(s). The memory 539, 541 stores software 533 implementing one or more innovations described herein, in the form of computer-executable instructions suitable for execution by the processing unit(s).

A computing system may have additional features. For example, the computing environment 531 includes storage 561, one or more input devices 571, one or more output devices 581, and one or more communication connections 591. An interconnection mechanism (not shown) such as a bus, controller, or network interconnects the components of the computing environment 531. Typically, operating system software (not shown) provides an operating environment for other software executing in the computing environment 531 (such as the software 533), and coordinates activities of the components of the computing environment 531.

The tangible storage 561 may be removable or non-removable, and includes magnetic disks, magnetic tapes or cassettes, CD-ROMs, DVDs, or any other medium which can be used to store information in a non-transitory way, and which can be accessed within the computing environment 531. The storage 561 can store instructions for the software 533 implementing one or more innovations described herein.

The input device(s) 571 may be a touch input device such as a keyboard, mouse, pen, or trackball, a voice input device, a scanning device, or another device that provides input to the computing environment 531. The output device(s) 581 may be a display, printer, speaker, CD-writer, or another device that provides output from computing environment 531.

The communication connection(s) 591 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed modes or methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In some embodiments, cloud-based resources can be used to manage, store, process, distribute, analyze, and/or execute any hardware, software, or firmware functionality. In addition, any of the described units, modules, or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. It should be understood that the term “computer-readable storage media” refers to physical storage media, and not signals, carrier waves, or other transient media.

### Illustrative Examples

The following examples are provided to illustrate certain aspects of the disclosed subject matter and to aid those of skill in the art in the art in practicing the disclosed subject matter. These examples, however, are in no way to be considered to limit the scope of the disclosed subject matter in any manner.

As an overview of an exemplary method of electrolyte soak characterization, initial excitation parameters (e.g., parameters 1120) can be provided as input into an electrolyte acceleration system (e.g., system 3000). These initial parameters may come from historical data (e.g., data 1201) or first test data. Once the initial excitation parameters are loaded, the method can proceed to soak acceleration, where ultrasound energy waves can be used to condition the electrolyte during the filling and soaking process. After soak acceleration, soak characterization can occur through the electrolyte assessment system (e.g., system 3000), where ultrasound energy waves are used to evaluate and characterize the battery, electrolyte, and/or soak acceleration process. From the resulting soak characterization data (e.g., data 1265), directed insights can be made through computational evaluation, and additional parameters for electrolyte filling and soaking acceleration can be defined. These additional parameters can then be applied as parameters for additional soak accelerations. In other words, the additional parameters can be insights that drive changes to the electrolyte acceleration parameters. These changes to the electrolyte acceleration parameters for soak acceleration may by fully automated or semi-automated. In some embodiments, the process of inputting initial and test parameters, soak acceleration, soak characterization, computing directed insights, gathering additional parameters and starting the soak acceleration process anew can be iterative, for example, until ideal electrolyte conditioning for soaking and filling of a battery cell or other technology is achieved or until some other metric has been achieved.

For electrolyte soak characterization, a computer system can be used to program configurable settings on an electronic device (e.g., a waveform generation system), whose purpose is to condition one or more analog or digital waveforms. Alternatively or additionally, the computer system can be used to program a configurable electronics device (e.g., a signal generator), whose purpose is to generate an analog or digital waveform. The signal generator (or equivalent device) generates one or more electrical waveforms that pass through the signal conditioner (or equivalent device) based on the computer parameters that were used to program both devices. The size and shape of the electrical signal may or may not vary over time. Further, during or in addition to these programming processes, one or more electrical waveforms (e.g., ultrasound energy frequencies) can be received by one or more ultrasound transducers or equivalent devices. The transducers generate an acoustic or ultrasound waveform. In one example, the output frequency of the acoustic or ultrasound signal emitted by the transducers for electrolyte soak optimization can be in a range between 0 Hz and 400 kHz. In another example, the emitted ultrasound can be in a range between 20 kHz and 400 kHz. In yet another example, the emitted ultrasound can be in a range between 200 kHz and 400 kHz. In still another example, the emitted ultrasound can be in a range between 500 kHz and 400 kHz.

After initial electrolyte soak characterization, the battery cell may be moved to a different ultrasound setup (the assessment system 1500 of acceleration system 4000). The assessment system can use a higher frequency ultrasound, e.g., in a range from 200 kHz to 20 MHz. The ultrasound waveforms pass through and reflect from the inner layers of the battery cell. The waveforms are received by electronics devices that decipher the data into digital codes, which codes can be interpreted by software algorithms to evaluate the soak quality. The feedback from the soak quality can be used to alter the ultrasound in the soak acceleration. The process is continued until the soak time and quality are optimized (or at least improved) and/or the soak characterization is complete.

For electrolyte acceleration, one or more ultrasound transducers can be used. Each transducer can receive an electrical excitation signal., which can originate from an electronic source that can provide various electrical signals and can be programmed to do so. The size and shape of the electrical signal can be varied over time. The frequency range of the ultrasound output for electrolyte conditioning is from 0 kHz to 400 kHz. The ultrasound can function as an agent to help lower the surface tension barriers that form between air-pockets and the electrolyte. The ultrasound can make electrolyte soak to completion more quickly than conventional methods. In other words, the ultrasound waveform accelerates the electrolyte soak completion time. Further, the ultrasound wave energy conditioning can make the electrolyte soak migration more uniform and complete across the battery cell.

In some embodiments, the conditioning and assessment aspects may be performed by two physically distinct systems. For the electrolyte filling process, the battery cell can be first placed next to at least one transducer that emits ultrasound energy waves in order to condition the electrolyte during the filling process. For example, the ultrasound energy waves emitted can be in a range from 0 kHz to 400 kHz. The ultrasound energy can lower the surface tension of the electrolyte such that the electrolyte filling process is faster, and the electrolyte soaking quality is equal to or better than slower conventional methods. After electrolyte conditioning, the battery cell can be moved for electrolyte assessment. In some embodiments, any collected data by the electrolyte conditioning can also be transferred to the electrolyte assessment system. The electrolyte assessment system can be used to evaluate the characteristics of the battery cell, including but not limited to state of health, state of charge, and electrolyte soaking efficiency. In some embodiments, the electrolyte assessment system can also utilize ultrasound energy waves from at least one transducer; however, the ultrasound energy waves used in the electrolyte assessment can have a larger range than the ultrasound energy waves used in the electrolyte conditioning system 1000. For example, the ultrasound energy waves used in the electrolyte assessment system can be between 200 kHz and 20 MHz. The data from the electrolyte assessment can be used to further refine and improve the electrolyte conditioning.

In some embodiments, the battery cell can be separately assessed via physical means, for example, by opening and imaging the filled battery cell so as to confirm that the electrolyte assessment results match the physical reality of the filled battery cell conditions. In some embodiments, the process for physically opening the battery cell can include tearing the battery cell apart and may be referred to as a “teardown” process. Any data resulting from the physical teardown process would then be considered teardown data. For example, the teardown data can include photographic cross-sectional images from at least one battery cell.

In some embodiments, an electrolyte acceleration system (e.g., either of systems 3000 or 4000) can direct their electrolyte assessment system (e.g., system 1500) to perform ultrasonic interrogation of a battery cell and an electrolyte of the battery cell, and to generate response signals in response to the ultrasonic interrogation. In some embodiments, a controller (e.g., controller 200 of the electrolyte assessment system) can be configured to correlate the response signals with teardown data of the interrogated battery cell to obtain correlated data, and to update a software algorithm (e.g., algorithm 1260) based at least in part on the correlated data. In some embodiments, a controller (e.g., controller 200) may be further configured to:
a) apply the response signals as input to the software algorithm (e.g., algorithm 1260), which in response creates soak characteristic data (e.g., data 1265) as output, where the soak characteristic data can predict electrolyte wetting quality or soak quality of the battery cell; and/or
b) pass the soak characteristic data as input to the conditioning system (e.g., system 1000), the assessment system (e.g., system 1500), or both, and the soak characteristic data can be used to adjust (e.g., via conditioning system 1000 or assessment system 1500) ultrasound transmitted into other battery cells when subjecting other battery cells to ultrasound (e.g., in performing an ultrasonic interrogation of the other battery cells and/or in performing electrolyte conditioning of the other battery cells).

In some embodiments, the electrolyte acceleration system can be a unified unit containing both an electrolyte conditioning system (e.g., system 1000-1) and the electrolyte assessment system (e.g., system 1500). In such embodiments, the battery cell can be placed such that at least one transducer (e.g., transducer 1230) can emit ultrasound energy waves in a range from 0 kHz to 400 kHz to accelerate electrolyte conditioning by lowering the surface tension of the electrolyte during the filling process. The now filled battery cell can remain in position with respect to the transducer(s) in order to subsequently undergo electrolyte assessment with ultrasound energy waves from 200 kHz to 20 MHz transmitted from the at least one transducer.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A System Comprising:
one or more first ultrasonic transducers constructed to transmit ultrasound at a first frequency into one or more structures having an electrolyte therein;
one or more second ultrasonic transducers constructed to transmit ultrasound at a second frequency into the one or more structures and to detect ultrasound transmitted through and/or reflected from the one or more structures, the second frequency being different than the first frequency; and
a controller comprising one or more processors and one or more non-transitory computer-readable storage media, the computer-readable storage media storing computer-readable instructions that, when executed by the one or more processors, cause the one or more processors to control one or more excitation parameters of the one or more first ultrasonic transducers responsive to the detected ultrasound.

### Clause 2. A System Comprising:

a first ultrasound processing system configured to emit ultrasound energy at a first frequency into a battery cell to condition an electrolyte of the battery cell;
a second ultrasound processing system configured to emit ultrasound energy at a second frequency into the battery cell, detect ultrasound transmitted through or reflected by the battery cell, generate electrical response signals associated with the detected ultrasound, and generate soak characteristic data indicative of an electrolyte wetting quality or a soak quality based upon the response signals, wherein the second frequency is different than the first frequency; and
a controller configured to adjust one or more excitation parameters of the first ultrasound processing system based on the soak characteristic data.

Clause 3. The system of any clause or example herein, in particular, Clause 2, wherein the second ultrasound processing system comprises the controller.

Clause 4. The system of any clause or example herein, in particular, any one of Clauses 1-3, wherein the first frequency is in a range of 20 kHz to 400 kHz, inclusive.

Clause 5. The system of any clause or example herein, in particular, any one of Clauses 1-4, wherein the second frequency is in a range of 200 kHz to 20 MHz, inclusive.

Clause 6. The system of any clause or example herein, in particular, any one of Clauses 1-5, wherein the second frequency is in a range of 500 kHz to 20 MHz, inclusive.

Clause 7. The system of any clause or example herein, in particular, any one of Clauses 2-6, wherein the soak characteristic data comprises at least one of ultrasound attenuation, time-of-flight, backscatter, phase shift, and resonance behavior.

Clause 8. The system of any clause or example herein, in particular, any one of Clauses 1-7, wherein the one or more excitation parameters comprise at least one of frequency, amplitude, pulse repetition rate, waveform shape, and number of pulses.

Clause 9. The system of any clause or example herein, in particular, any one of Clauses 2-8, wherein the second ultrasound processing system is further configured to generate a two-dimensional image or a three-dimensional image of an interior of the battery cell.

Clause 10. The system of any clause or example herein, in particular, any one of Clauses 2-9, wherein the controller is configured to execute a machine learning model trained on prior soak characteristic data to generate updated excitation parameters.

Clause 11. The system of any clause or example herein, in particular, any one of Clauses 2-10, wherein the first ultrasound processing system is configured to emit ultrasound energy at the first frequency into the battery cell during a manufacturing wetting and soaking phase of the battery cell.

Clause 12. A method Comprising:
directing ultrasound at a first frequency into one or more structures having an electrolyte therein;
directing ultrasound at a second frequency different than the first frequency into the one or mores structures, and detecting ultrasound transmitted through and/or reflected from the one or more structures in response thereto;
determining one or more adjusted excitation parameters based at least in part on the detected ultrasound; and
repeating the directing ultrasound with the adjusted excitation parameters into the same one or more structures or a subsequent structure.

Clause 13. A method comprising:
applying ultrasound energy to a battery cell at a first frequency to promote electrolyte infiltration of the battery cell;
interrogating the battery cell using ultrasound energy at a second frequency to assess electrolyte wetting or soak characteristics, wherein the second frequency is different than the first frequency; and
adjusting one or more excitation parameters of the applying step based on feedback from the interrogating.

Clause 14. The method of any clause or example herein, in particular, Clause 13, further comprising:
determining an electrolyte wetting index based on data from the interrogating.

Clause 15. The method of any clause or example herein, in particular, any one of Clauses 12-14, wherein:
the first ultrasound frequency is applied during a manufacturing electrolyte wetting and soaking phase of the battery cell, and
the second ultrasound frequency is applied during or after the manufacturing electrolyte wetting and soaking phase of the battery cell.

Clause 16. The method of any clause or example herein, in particular, any one of Clauses 13-15, wherein the adjusting comprises modulation of frequency or amplitude of the excitation parameters during electrolyte wetting and soaking of either the battery cell or of other battery cells.

Clause 17. The method of any clause or example herein, in particular, any one of Clauses 13-16, further comprising:
generating soak characteristic data indicative of an electrolyte wetting quality or a soak quality of the battery cell, from response signals generated in response to the generating, and
storing the soak characteristic data in a data repository.

Clause 18. A system comprising:
an ultrasound assessment system configured to perform ultrasonic interrogation of a battery cell and an electrolyte of the battery cell, and to generate response signals in response to the ultrasonic interrogation; and
a controller configured to correlate the response signals with teardown data of the interrogated battery cell to obtain correlated data, and to update a software algorithm based on the correlated data;
wherein the controller is further configured to:
   apply the response signals as input to the software algorithm, which in response creates soak characteristic data as output, and wherein the soak characteristic data predicts electrolyte wetting quality or soak quality of the battery cell; and
   pass the soak characteristic data as input to the ultrasound assessment system, and the ultrasound assessment system uses the soak characteristic data to adjust ultrasound transmitted into other battery cells when performing ultrasonic interrogation of the other battery cells.

Clause 19. The system of any clause or example herein, in particular, Clause 18, wherein the teardown data includes photographic cross-sectional images from at least one battery cell.

Clause 20. The system of any clause or example herein, in particular, any one of Clauses 18-19, wherein the controller is further configured to perform matching between the response signals and the photographic cross-sectional images of the teardown data.

Clause 21. The system of any clause or example herein, in particular, any one of Clauses 18-20, wherein:
the software algorithm comprises a neural network that is configured to predict electrolyte wetting quality of the electrolyte of the battery cell, and
the controller passes the response signals as input to the software algorithm and obtains the predicted electrolyte wetting quality of the electrolyte of the battery cell as output.

Clause 22. The system of any clause or example herein, in particular, any one of Clauses 18-21, further comprising:
training data including ultrasound interrogation data from one or more other battery cells,
wherein the software algorithm is trained using the training data, prior to the controller passing the response signals of the battery cell as input to the software algorithm to obtain the predicted electrolyte wetting quality of the electrolyte of the battery cell as output.

Clause 23. The system of any clause or example herein, in particular, any one of Clauses 18-22, wherein the ultrasound assessment system includes:
a waveform generation system configured to access excitation parameters and generate corresponding electrical excitation signals in response;
a waveform conditioning system configured to receive the excitation signals from the waveform generation system and to modify the excitation signals based upon the soak characteristic data; and
at least one ultrasound transducer configured to receive the excitation signals sent from the waveform conditioning system, and to transmit ultrasound into the other battery cells in response to receiving the excitation signals,
wherein the ultrasound assessment system uses the soak characteristic data to adjust the ultrasound transmitted into other battery cells when performing ultrasonic interrogation of the other battery cells.

Clause 24. A method for processing an electrolyte within or provided to a structure, such as a manufactured battery cell or a battery cell being manufactured, using ultrasound according to any clause or example herein.

Clause 25. A system configured to process an electrolyte within or provided to a structure, such as a manufactured battery cell or a battery cell being manufactured, using ultrasound according to any clause or example herein.

### Conclusion

Although energy storage devices (e.g., battery cells), components, and configuration have been illustrated in the figures and discussed in detail herein, embodiments of the disclosed subject matter are not limited thereto. Indeed, one of ordinary skill in the art will readily appreciate that different energy storage devices, components, or configurations can be selected and/or components added to provide the same effect. It can also be appreciated that principles of the disclosed subject matter can be applied to battery cells other than lithium-ion battery cells that also include a liquid electrolyte, such as but not limited to lithium sulfur and lithium iron phosphate batteries. Moreover, in practical implementations, embodiments may include additional components or other variations beyond those illustrated. Accordingly, embodiments of the disclosed subject matter are not limited to the particular batteries, components, and configurations specifically illustrated and described herein.

Further, although embodiments and examples have been described in the context of implementation in a particular environment, and for particular purposes (e.g., electrolyte acceleration), those skilled in the art will recognize that the utility of the disclosed subject matter is not limited thereto and that aspects of the disclosed subject matter can be beneficially utilized in other environments and implementations, for example, where it may be desirable to assess the electrolyte during battery filling, to evaluate the electrolyte after battery filling, to accelerate electrolyte filling and soaking processes for applications outside of batteries, etc.

Any of the features illustrated or described herein, for example, with respect to FIGS. 1A-6 and/or Clauses 1-25, can be combined with any other feature illustrated or described herein to provide systems, devices, structures, methods, and embodiments not otherwise illustrated or specifically described herein. All features described herein are independent of one another and, except where structurally impossible, can be used in combination with any other feature described herein.

It will also be recognized by those skilled in the art that, while the invention has been described above in terms of examples and embodiments, it is not limited thereto. Various features and aspects of the above-described embodiments may be used individually or jointly. In view of the many possible embodiments to which the principles of the disclosed technology may be applied, it should be recognized that the illustrated embodiments are only examples and should not be taken as limiting the scope of the disclosed technology. Rather, the scope is defined by the following claims. Applicant therefore claims all that comes within the scope and spirit of these claims.

1. A system comprising:
a first ultrasound processing system configured to emit ultrasound energy at a first frequency into a battery cell to condition an electrolyte of the battery cell;
a second ultrasound processing system configured to:
emit ultrasound energy at a second frequency into the battery cell, the second frequency being different than the first frequency;
detect ultrasound transmitted through or reflected by the battery cell;
generate electrical response signals associated with the detected ultrasound; and
generate soak characteristic data indicative of an electrolyte wetting quality or a soak quality based upon the response signals; and
a controller of the second ultrasound processing system configured to adjust one or more excitation parameters of the first ultrasound processing system based on the soak characteristic data.

2. The system of claim 1, wherein the first frequency is in a range from 20 kHz to 400 kHz, inclusive.

3. The system of claim 1, wherein the second frequency is in a range from 200 kHz to 20 MHz, inclusive.

4. The system of claim 1, wherein the second frequency is in a range from 500 kHz to 20 MHz, inclusive.

5. The system of claim 1, wherein the soak characteristic data comprises at least one of ultrasound attenuation, time-of-flight, backscatter, phase shift, and resonance behavior.

6. The system of claim 1, wherein the one or more excitation parameters comprise at least one of frequency, amplitude, pulse repetition rate, waveform shape, and number of pulses.

7. The system of claim 1, wherein the second ultrasound processing system is further configured to generate a two or three-dimensional image of an interior of the battery cell.

8. The system of claim 1, wherein the controller is configured to execute a machine learning model trained on prior soak characteristic data to generate updated excitation parameters.

9. The system of claim 1, wherein the first ultrasound processing system is configured to emit the ultrasound energy at the first frequency into the battery cell during a manufacturing wetting and soaking phase of the battery cell.

10. A method comprising:
applying ultrasound energy to a battery cell at a first frequency to promote electrolyte infiltration of the battery cell;
interrogating the battery cell using ultrasound energy at a second frequency to assess electrolyte wetting or soak characteristics, the second frequency being different than the first frequency; and
adjusting one or more excitation parameters of the applying based on feedback from the interrogating.

11. The method of claim 10, further comprising:
determining an electrolyte wetting index based on data from the interrogating.

12. The method of claim 10, wherein:
the ultrasound energy at the first frequency is applied during a manufacturing electrolyte wetting and soaking phase of the battery cell, and
the ultrasound energy at the second frequency is applied during or after the manufacturing electrolyte wetting and soaking phase of the battery cell.

13. The method of claim 10, wherein the adjusting comprises modulation of frequency or amplitude of the one or more excitation parameters during electrolyte wetting and soaking of either the battery cell or of other battery cells.

14. The method of claim 10, further comprising:
generating soak characteristic data indicative of an electrolyte wetting quality or a soak quality of the battery cell, from response signals generated in response to the generating, and
storing the soak characteristic data in a data repository.

15. A system comprising:
an ultrasound assessment system configured to:
perform ultrasonic interrogation of a battery cell and an electrolyte of the battery cell, and
generate response signals in response to the ultrasonic interrogation; and
a controller configured to:
correlate the response signals with teardown data of the interrogated battery cell to obtain correlated data, and
update a software algorithm based on the correlated data, wherein the controller is further configured to:
apply the response signals as input to the software algorithm, which in response creates soak characteristic data as output, and wherein the soak characteristic data predicts electrolyte wetting quality or soak quality of the battery cell; and
pass the soak characteristic data as input to the ultrasound assessment system, and
wherein the ultrasound assessment system is configured to use the soak characteristic data to adjust ultrasound transmitted into other battery cells when performing ultrasonic interrogation of the other battery cells.

16. The system of claim 15, wherein the teardown data includes photographic cross-section images from at least one battery cell.

17. The system of claim 16, wherein the controller is further configured to perform matching between the response signals and the photographic cross-section images of the teardown data.

18. The system of claim 15, wherein:
the software algorithm comprises a neural network that is configured to predict electrolyte wetting quality of the electrolyte of the battery cell, and
the controller is configured to pass the response signals as input to the software algorithm and obtain the predicted electrolyte wetting quality of the electrolyte of the battery cell as output.

19. The system of claim 18, further comprising:
training data including ultrasound interrogation data from one or more other battery cells,
wherein the software algorithm is trained using the training data, prior to the controller passing the response signals of the battery cell as input to the software algorithm to obtain the predicted electrolyte wetting quality of the electrolyte of the battery cell as output.

20. The system of claim 15, wherein the ultrasound assessment system includes:
a waveform generation system configured to access excitation parameters and generate corresponding electrical excitation signals in response;
a waveform conditioning system configured to receive the excitation signals from the waveform generation system and to modify the excitation signals based upon the soak characteristic data; and
at least one ultrasound transducer configured to receive the excitation signals sent from the waveform conditioning system, and to transmit ultrasound into the other battery cells in response to receiving the excitation signals,
wherein the ultrasound assessment system uses the soak characteristic data to adjust the ultrasound transmitted into other battery cells when performing ultrasonic interrogation of the other battery cells.
